(19) United States
(12) Patent Application Publication
(10) Pub. No.: US 2016/0139397 A1
(43) Pub. Date: May 19, 2016

(54) Specimen Stand

(71) Applicant: Noah Fram-Schwartz, Mountain View, CA (US)

(72) Inventor: Noah Fram-Schwartz, Mountain View, CA (US)

(21) Appl. No.: 14/942,464

(22) Filed: Nov. 16, 2015

Related U.S. Application Data
(60) Provisional application No. 62/080,306, filed on Nov. 15, 2014.

(51) Int. Cl. G02B 21/26; G02B 21/34

(52) U.S. Cl. CPC G02B 21/26; G02B 21/34

(57) ABSTRACT

A specimen stand includes a base, a support, an “L”-shaped arm, and a specimen-holding portion. The specimen-holding portion is rotatable relative to the “L”-shaped arm. The “L” support arm is rotatable relative to the support and the base. The specimen stand has a swappable plate having distinct colors to allow specimens to be positioned over different colors for examination. The specimen stand has a magnet on the base to assist in positioning the base.

### CROSS-REFERENCE TO RELATED APPLICATIONS

This patent claims the benefit of U.S. Patent Application 62/080,306 which was filed on Nov. 15, 2014 and which is incorporated herein by reference.

### TECHNICAL FIELD

The present invention relates generally to a specimen stand, in particular a specimen stand for entomology for positioning the insect for use with other devices such as a microscope.

### BACKGROUND

Entomology is the study of insects. The study of entomology includes many pursuits including insect biology in both basic and applied contexts. This can include examination using lenses. The majority of Entomological Microscopy is performed using low power (typically stereo zoom or digital) microscopes. Most entomologists also wish to capture high resolution images of their specimens.

It has been recognized that it is desired to study the insect without having to touch the specimen. There are specimen stands that allow a pinned specimen to be rotated on two independent axes, while maintaining a relatively accurate focus under a microscope.

### SUMMARY

It has been recognized that a background of different colors is desired dependent on the item to be examined. In addition, it is recognized that it is desired to have a magnet in the base for securing the stand.

In an embodiment, a specimen stand includes a base, a support, an “L”-shaped arm, and a specimen-holding portion. The base has an upper surface and lower surface. The support projects upward from the upper surface of the base. The arm is pivotably mounted to the support. The specimen-holding portion is carried by the arm. The specimen stand has a magnetic sheet carried by the base for securing the stand to a surface such as a table.

In an embodiment, the specimen stand has a swappable plate having a first color on one side and a second color on a second side. The swappable plate is carried by the upper surface of the base. In an embodiment, the upper surface of the base of the specimen stand is a different color than the first color and the second color of the swappable plate.

In an embodiment, the upper surface of the base has a pair of “L”-shaped projections defining a pair of grooves for retaining the swappable plate to the upper surface of the base.

In an embodiment, the base has a storage area for receiving for the swappable plate.

In an embodiment, the lower surface of the base has a rectangular recess for receiving the magnetic sheet.

It is to be understood that the features of the various embodiments described herein are not mutually exclusive and may exist in various combinations and permutations.

### BRIEF DESCRIPTION OF THE SEVERAL VIEWS OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a specimen stand according to the invention:

FIG. 2 is a sectional view of the specimen stand;

FIG. 3 is a front view of the specimen stand;

FIG. 4 is a bottom view of the specimen stand;

FIG. 5 is an exploded view of the specimen stand;

FIG. 6 is another perspective view of the specimen stand; and

FIG. 7 is a perspective view of an insect on the specimen stand and a lens of a camera.

### DETAILED DESCRIPTION

A specimen stand provides multiple swappable plates for background options to allow the user to examine and photograph a specimen. The specimen stand allows the user to move a specimen without having to touch the specimen. The specimen stand has a weighted magnetic base.

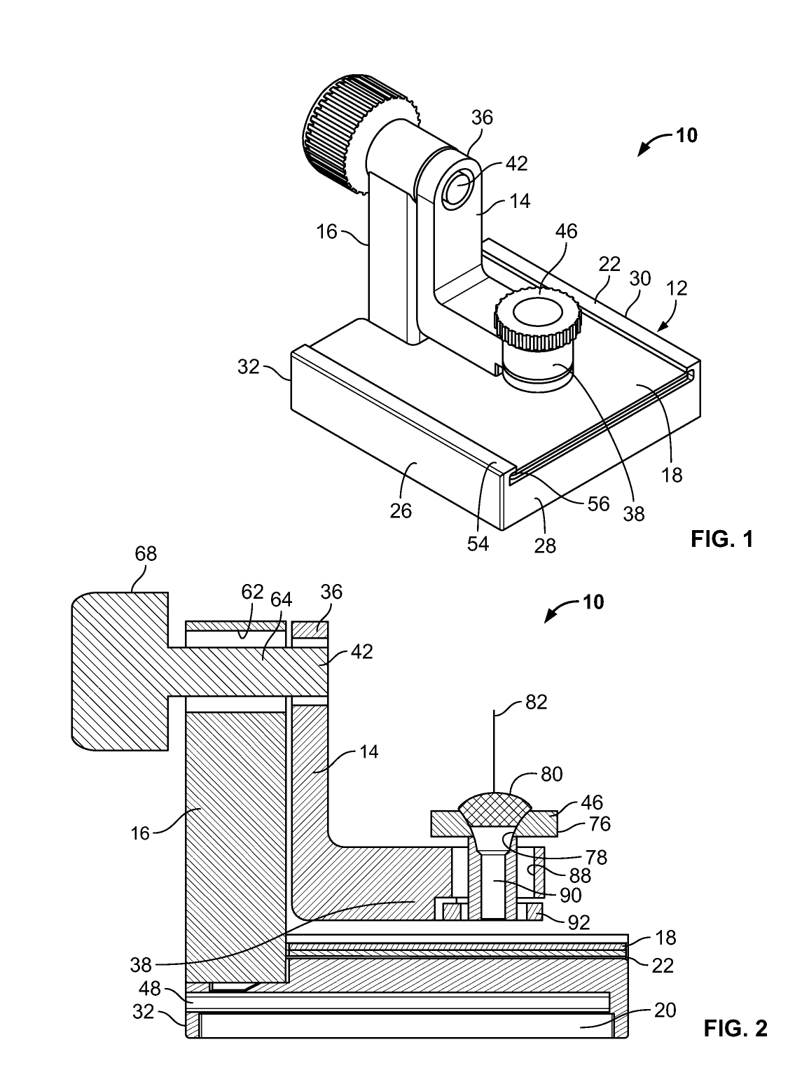

Referring to FIG. 1, a perspective view of a specimen stand 10 is shown. The specimen stand 10 has a base 12 and a “L”-shaped arm 14. The base 12 has an upper surface 22, a lower surface 24, as seen in FIG. 4, and a plurality of side walls 26, 28, 30, and 32. To assist in describing the specimen stand 10, two of the side walls 28 and 32 are also referred as a front wall 28 and a rear wall 32.

The specimen stand 10 has a support 16 that projects upward from the upper surface 22 of the base 12. The “L”-shaped arm 14 has a first end 36 that is pivotably mounted to the support 16 by a fastener 42. The “L”-shaped arm 14 has a second end 38. The specimen stand 10 has a specimen-rotating portion 46 that is rotatably connected to the “L”-shaped arm 14 at the second end 38.

The specimen stand 10 has a swappable plate 18 that is received on the upper surface 22 of the base 12. The base 12 has a pair of “L”-shaped projections 54 that extend upward and inward to each define a groove 56. The groove 56 extends from the front wall 28 to the rear wall 32. Each groove 56 receives one of a pair of edges of the swappable plate 18 to retain the swappable plate 18.

Referring to FIG. 2, a sectional view of the specimen stand 10 is shown. The support 16 has a hole 62 through which a shaft 64 of the fastener 42 extends from the first end 36 of the “L”-shaped arm 14. The shaft 64 of the fastener 42 ends in a knurled knob 68.

The specimen-rotating portion 46 has a base 76 with a groove (dimple) 78 to receive plastine 80 into which a pin or wire 82 containing the insect can be secured. The second end 38 of the “L”-shaped arm 14 has a hole 88 through which a shaft 90 of the specimen-rotating portion 46 extends. An annular ring 92 receives the other end of the shaft 90 of the specimen-rotating portion 46.

The swappable plate 18 is shown on the upper surface 22. The base 10 has a slot 48 that opens onto the rear wall 32 and is a storage area for the swappable plate 18. The specimen stand 10 has a magnetic plate 20 which is received in a groove or rectangular recess 96 on the lower surface 24. The magnetic plate 20 in one embodiment is secured by epoxy to the rectangular recess.

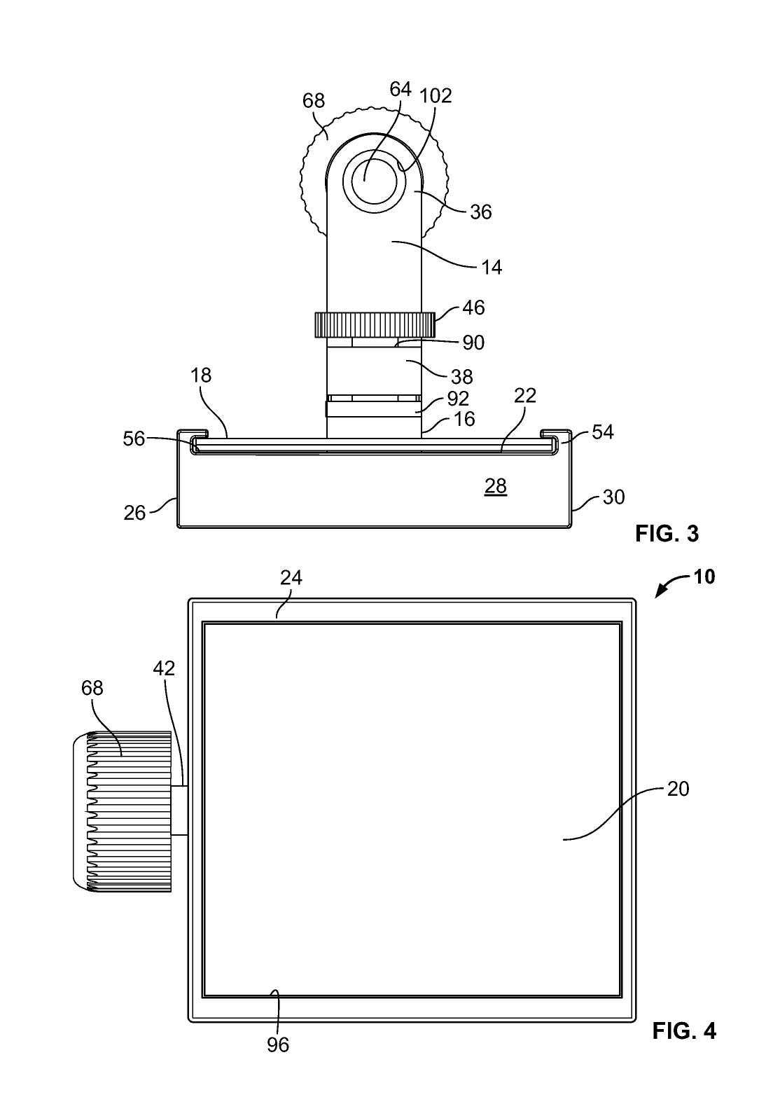

Referring to FIG. 3, a front view of the specimen stand 10 is shown. The support 16 projects from the upper surface 22 of the base 12 of the specimen stand. The first end 36 of the “L”-shaped arm 14 has a hole 102 that receives the shaft 64 of the fastener 42. The knurled knob 68 is seen behind the support 16.

The specimen-rotating portion 46 is rotatably mounted to the second end 38 of the “L”-shaped arm 14. The swappable plate 18 of the specimen stand 10 is received on the upper surface 22 of the base 12. The pair of “L”-shaped projections 54 of the base 12 extend upward and inward to each define a groove 56. The groove 56 extends from the front wall 28 to the rear wall 32. Each groove 56 receives one of a pair of edges of the swappable plate 18 to retain the swappable plate 18.

Referring to FIG. 4, a bottom view of the specimen stand 10 is shown. The magnetic plate 20 of the specimen stand 10 is received in the groove or rectangular recess 96 on the lower surface 24. The magnetic plate 20 in one embodiment is secured by epoxy to the rectangular recess 96. The magnetic plate is not a strong magnet but strong enough to keep the specimen stand 10 in place.

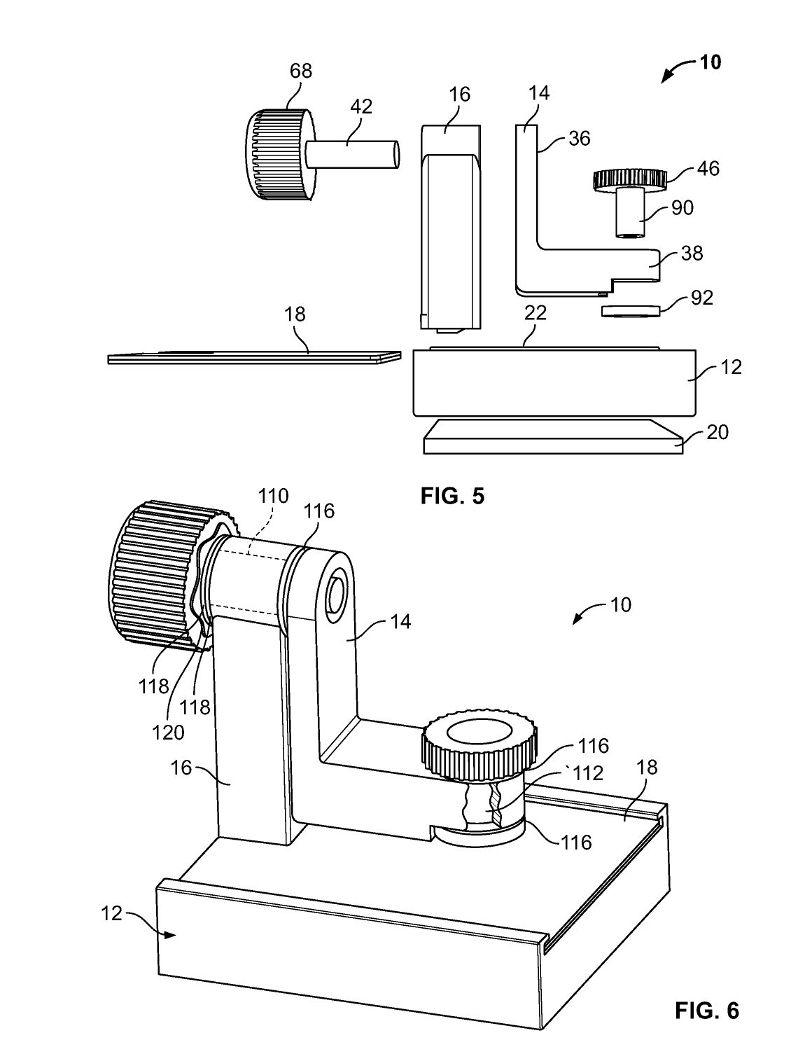

Referring to FIG. 5, an exploded view of the main components of the specimen stand 10 is shown. The support 16 is shown projecting upward from the base 12 of the specimen stand 10. The “L”-shaped arm 14 is shown spaced from the support 16 with the fastener 42 with the knurled knob 68.

The “L”-shaped arm 14 has a second end 38. The specimen-rotating portion 46 of the specimen stand 10 is shown about the second end 38 of the “L”-shaped arm 14. The annular ring 92 which receives the shaft 90 of the specimen-rotating portion 46 is shown below the second end 38.

The specimen stand 10 has a swappable plate 18 that is received on the upper surface 22 of the base 12. While the swappable plate 18 is shown on the left of the the base 12 in FIG. 5, the swappable plate 18 is received on the upper surface 22 of the base 12 and in the grooves 56 formed by the “L”-shaped projection 54 from the right side; the swappable plate 18 is received by the slot 48 of the base 12 from the left in the FIG.

In an embodiment, the specimen stand 10 including the base 12, the “L”-shaped arm 14, the support 16, and the specimen-rotating portion 46 is formed using a 3D printing process. The components are printed using a fused deposition modeling (FDM) technique.

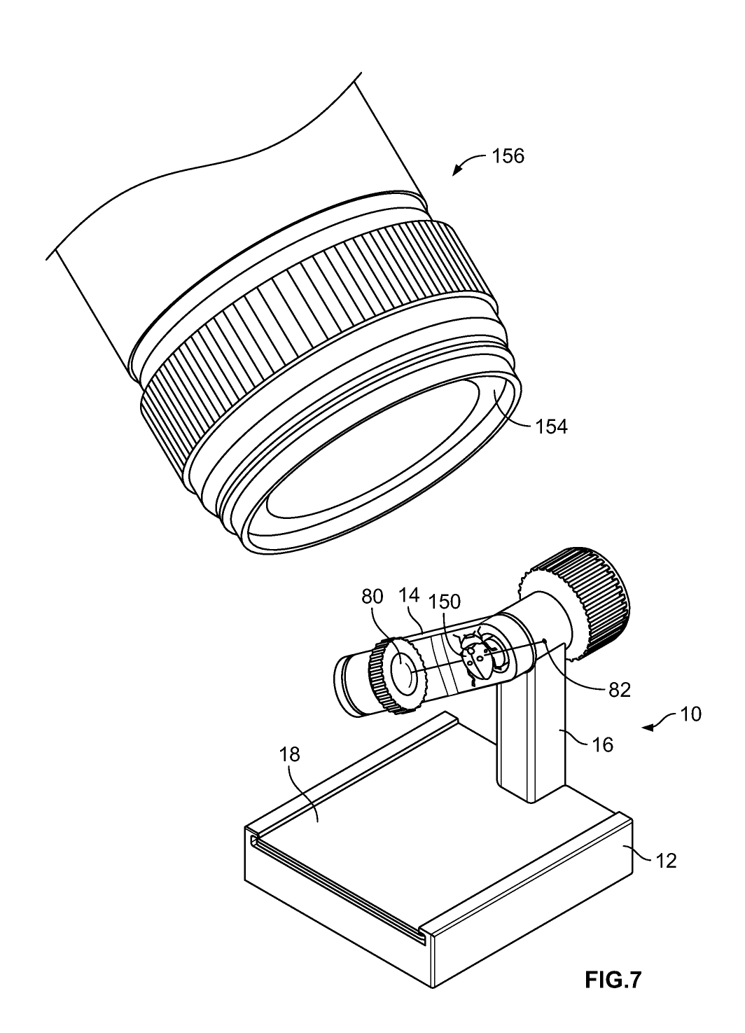

Referring to FIG. 6, another perspective view of the specimen stand 10 is shown. The specimen stand 10 has a pair of brass tubing 110 and 112: one brass tube 110 in the hole 62 of the support 16 and the second one 112 in the hole at the second of the “L”-shaped arm 14. The brass tubing 110, shown in hidden line, and 112 is to make for smoother rotation of the “L”-shaped arm 14 and the specimen-rotating portion 46. In addition to the brass tubing, the specimen stand 10 has several washers including a plurality of nylon washers 116. Interposed between the knurled knob 68 and the support 16 is a series of washers, including a pair of nylon washers 118, and an interposed wavy spring washer 120. The knurled knob 68 is press-fit into the L-shaped arm 14 and glued with epoxy.

Referring to FIG. 7, a perspective view of an insect 150 on the specimen stand 10 and a lens 154 of a camera 156 is shown. The specimen stand 10 has the base 12 and the “L”-shaped arm 14. The support 16 of the specimen stand 10 projects upward from the upper surface 22 of the base 12. The “L”-shaped arm 14 has a first end 36 that is pivotably mounted to the support 16 by a fastener 42. The “L”-shaped arm 14 has a second end 38. The specimen stand 10 has a specimen-rotating portion 46 that is rotatably connected to the “L”-shaped arm 14 at the second end 38.

The swappable plate 18 of the specimen stand 10 is received on the upper surface 22 of the base 12.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that in an alternative embodiment, the magnetic plate 20 is replaced by a non-skid surface.

1. A specimen stand comprising:
a base having an upper surface and lower surface;
a support that projects upward from the upper surface of the base;
an arm that is pivotably mounted to the support;
a specimen-holding portion carried by the arm; and
a magnetic sheet carried by the base.

2. A specimen stand of claim 1 further comprising a swappable plate having a first color on one side and a second color on a second side, the swappable plate can be carried by the upper surface of the base.

3. A specimen stand of claim 2 wherein the first color of the swappable plate is white and the second color is black.

4. A specimen stand of claim 3 wherein the upper surface of the base of the specimen stand is a different color than the first color and the second color of the swappable plate.

5. A specimen stand of claim 2 where the upper surface of the base has a pair of “L”-shaped projections defining a pair of grooves for retaining the swappable plate to the upper surface of the base.

6. A specimen stand of claim 2 wherein the base has a storage area for receiving for the swappable plate.

7. A specimen stand of claim 1 wherein the lower surface of the base has a rectangular recess for receiving the magnetic sheet.

8. A specimen stand of claim 1 wherein the specimen-holding portion is rotatable relative to the arm.

9. A specimen stand comprising:
a base having an upper surface and lower surface;
a support that projects upward from the upper surface of the base;
an arm that is pivotably mounted to the support;
a specimen-holding portion carried by the arm; and
a swappable plate having a first color on one side and a second color on a second side.

10. A specimen stand of claim 9 wherein the first color of the swappable plate is white and the second color is black.

11. A specimen stand of claim 10 wherein the upper surface of the base of the specimen stand is a different color than the first color and the second color of the swappable plate.

12. A specimen stand of claim 9 where the upper surface of the base has a pair of “L”-shaped projections defining a pair of grooves for retaining the swappable plate to the upper surface of the base.

13. A specimen stand of claim 9 wherein the base has a storage area for receiving for the swappable plate.

14. A specimen stand of claim 9 further comprising a magnetic sheet carried by the base for securing the specimen stand.

15. A specimen stand of claim 14 wherein the lower surface of the base has a rectangular recess for receiving the magnetic sheet.

16. A specimen stand of claim 9 further comprising a non-skid surface carried by the base for securing the specimen stand.

17. A specimen stand of claim 9 wherein the specimen holder is rotatable relative to the arm to move the specimen relative to the arm and the base.

18. A specimen stand for entomology comprising:
a base having an upper surface, a lower surface, and a plurality of side walls;
a support that projects upward from the upper surface of the base;
an “L”-shaped arm that is pivotably mounted to the support, the “L”-shaped arm has an opening at the first end and an opening at the second end;
a securing mechanism for securing the “L”-shaped arm in a position relative to the base and the support;
a specimen-holder portion is rotatable relative to the arm to move the specimen relative to the arm and the base;
a magnetic sheet carried by the base for securing the specimen stand; and
a swappable plate having a first color on one side and a second color on a second side.

19. A specimen stand of claim 18 wherein the base has a storage area for receiving for the swappable plate.

20. A specimen stand of claim 19 wherein the first color is white of the swappable plate and the second color is black.

21. A specimen stand of claim 20 further comprising a second swappable plate having at least one distinct color.

22. A specimen stand of claim 20 wherein the upper surface of the base of the specimen stand is a different color than the first color and the second color of the swappable plate.

23. A specimen stand of claim 19 where the upper surface of the base has a pair of “L”-shaped projections defining a pair of grooves for retaining the swappable plate to the upper surface of the base.

24. A specimen stand of claim 19 wherein the lower surface of the base has a rectangular recess for receiving the magnetic sheet.

25. A specimen stand for entomology of claim 18 wherein the specimen-holding portion has a groove adapted to receive a plasticine to hold a pin and specimen.
